(19) United States
(12) Patent Application Publication
(10) Pub. No.: US 2009/0317105 A1
(43) Pub. Date: Dec. 24, 2009

(54) DEVELOPING DEVICE AND IMAGE FORMING APPARATUS

(75) Inventors: Yoshinori TSUTSUMI, Toyokawa-shi (JP); Katsuyuki Hirata, Toyokawa-shi (JP); Kazuomi Sakatani, Sagamihara-shi (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Chiyoda-ku (JP)

(21) Appl. No.: 12/486,027

(22) Filed: Jun. 17, 2009

(30) Foreign Application Priority Data
Jun. 19, 2008 (JP) 2008-160477

(51) Int. Cl. G03G 15/08

(52) U.S. Cl. 399/53; 399/254; 399/255

(57) ABSTRACT

A developer is appropriately replenished at the desired toner concentration even with bare minimum stirring. A developer container (11) in which a developer containing toner and carrier is received, a developer replenishing container (23) in which a developer containing toner and carrier is received and which replenishes the developer container (11) with the developer, a replenishment path (25) which connects a upper portion of the developer container 11 with an lower portion of the developer replenishing container (23), stirring member (24) for stirring the developer in the developer replenishing container (23), toner concentration detecting member (27) for detecting the toner concentration of the developer in the replenishment path (25), and control unit (6) for stirring the developer in the developer replenishing container (23) by controlling driving of the stirring member (24) on the basis of the toner concentration detected by the toner concentration detecting member (27) are provided.

### CROSS-REFERENCE TO RELATED APPLICATION

This application is based on application No. 2008-160477 filed in Japan, the entire content of which is hereby incorporated by reference.

### BACKGROUND OF THE INVENTION

The present invention relates to a developing device and an image forming apparatus.

Conventionally, in a developing device, replenishment of toner into a developer container is controlled on the basis of a toner concentration detected from a toner concentration detecting sensor provided in the developer container and print rate information on a printed paper.

When the developer to be replenished into the developer container is a two-component developer constituted of toner and carrier (so-called trickle system), variation tends to occur in the toner concentration of the developer. This is because the toner and carrier have large differences in the physical properties (particularly specific gravity) besides the material factors and are not easily uniformly dispersed.

Accordingly, for example, a construction in which the developer in a developer replenishing container is stirred and mixed to be replenished into the developer container in a uniform state is disclosed (refer to, for example, Patent Document 1).

Patent Document 1: JP 2006-201474 A

However, in the conventional construction described above, the developer in the developer replenishing container is merely stirred without considering differences in the environmental conditions such as temperature and humidity and differences in the stirring conditions such as stirring speed and stirring time. Accordingly, there are problems that the deterioration of the carrier is disadvantageously promoted as a consequence of stirring more than necessary and that the desired toner concentration cannot be achieved due to shortage of stirring.

### SUMMARY OF THE INVENTION

An object of the present invention is to provide a developing device and an image forming apparatus capable of properly replenishing a developer of the desired toner concentration even with bare minimum stirring.

As a means for solving the above problems, the invention provides a developing device including:

a developer container in which a developer containing toner and carrier is received;

a developer replenishing container in which a developer containing toner and carrier is received and which replenishes the developer container with the developer;

a replenishment path which connects a upper portion of the developer container with an lower portion of the developer replenishing container;

stirring member for stirring the developer in the developer replenishing container;

toner concentration detecting member for detecting a toner concentration of the developer in the replenishment path; and

control unit for stirring the developer in the developer replenishing container by controlling driving of the stirring member on the basis of the toner concentration detected by the toner concentration detecting member.

With the above construction, it can be judged whether or not to stir the developer in the developer replenishing container on the basis of the toner concentration of the developer immediately before the developer is replenished into the developer container. Therefore, if it seems that variation occurs in the toner concentration in the developer replenishing container and it would exert influences on the developer to be replenished into the developer container, the developer in the developer container is stirred by the stirring member, allowing the toner concentration to be adjusted.

When the toner concentration detected by the toner concentration detecting member is higher than a preset reference concentration, it is proper for the control unit to control driving of the stirring member at a stirring speed smaller than a reference speed.

That is, when the toner concentration is higher than the reference concentration, a rate that the carrier of a specific gravity greater than that of the toner is located on the lower side is low, and therefore, the stirring by the stirring member is made slow. Normally, in the developer replenishing container, the carrier tends to gather on the lower side, or the replenishment position, and proper toner management is set in a state in which the rate of the carrier is greater than the total toner concentration of the developer in the developer replenishing container. Therefore, the stirring speed by the stirring member is set within a range in which the carrier easily gathers on the lower side by its own gravity compared to the case where the toner and the carrier are stirred and mixed. With this arrangement, it is possible to make the toner concentration on the lower side, which the replenishment position of the developer replenishing container, fall within a proper range.

When the toner concentration detected by the toner concentration detecting member is lower than the preset reference concentration, it is proper for the control unit to control driving of the stirring member at a stirring speed greater than the reference speed.

With the above construction, the carrier gathering on the lower side, or the replenishment position is dispersed, allowing the toner concentration to be adjusted to the proper range.

The control unit may increase or decrease the stirring speed by controlling driving of the stirring member in accordance with the level of the toner concentration detected by the toner concentration detecting member.

With the above construction, it is possible to finely control the stirring speed by the stirring member in accordance with a difference in the detected toner concentration, and the concentration of the toner to be replenished into the developer container is allowed to consistently fall within the proper range.

It is preferable that the device has magnetizing member capable of temporarily magnetizing the stirring member, and

the control unit captures the carrier in the developer replenishing container by temporarily magnetizing the stirring member by the magnetizing member when the toner concentration detected by the toner concentration detecting member is lower than the preset reference concentration.

Moreover, it is also possible that the device has magnetizing member capable of temporarily magnetizing the developer replenishing container, and

the control unit captures the carrier in the developer replenishing container by temporarily magnetizing the developer replenishing container by the magnetizing member when the toner concentration detected by the toner concentration detecting member is lower than the preset reference concentration.

Moreover, as a means for solving the above problems, the invention provides a developing device including:

a developer container in which a developer containing toner and carrier is received;

a developer replenishing container in which a developer containing toner and carrier is received and which replenishes the developer container with the developer;

a replenishment path which connects a lower portion of the developer container with an upper portion of the developer replenishing container;

stirring member for stirring the developer in the developer replenishing container;

toner concentration detecting member for detecting a toner concentration of the developer in the replenishment path;

magnetizing member for magnetizing at least an inner surface of the developer replenishing container or at least a stirring paddle of the stirring member; and

control unit for capturing the carrier in the developer replenishing container by temporarily magnetizing either one of the developer replenishing container and the stirring member by the magnetizing member when the toner concentration detected by the toner concentration detecting member is lower than a preset reference concentration.

With the above construction having the magnetizing member, the carrier can be caught in the developer replenishing container by the magnetizing member when the detected toner concentration is lower than the reference concentration. Therefore, the toner concentration of the developer replenished into the developer container can be restored to the reference concentration.

In the above case, if the magnetism generated by the magnetizing member is increased or decreased in accordance with the level of the detected toner concentration, the toner concentration caught in the developer container can be further adjusted to the proper range.

Moreover, as a means for solving the above problems, the invention provides a developing device including:

a developer container in which a developer containing toner and carrier is received;

a developer replenishing container in which a developer containing toner and carrier is received;

stirring member for stirring the developer in the developer replenishing container;

a replenishment path which connects the developer container with the developer replenishing container and replenishes the developer container with the developer;

a hopper which is connected somewhere along the replenishment path and temporarily retains the developer directed from the developer replenishing container toward the developer container;

toner concentration detecting member for detecting a toner concentration of the developer in the hopper; and

control unit for permitting replenishment of the developer from the hopper to the developer container when the toner concentration detected by the toner concentration detecting member is within the preset reference range, refusing the replenishment when the concentration is outside the reference range, adjusting the toner concentration by controlling driving of the stirring member and thereafter making the hopper supply the developer.

According to the above construction, by detecting the toner concentration of the developer retained in the hopper, a value more accurate than when detecting the developer passing through the replenishment path can be obtained. Then, by replenishing the developer in the hopper as it is to the developer container or replenishing the developer from the developer replenishing container by controlling driving of the stirring member on the basis of the detected toner concentration, the toner concentration of the developer in the hopper can be adjusted or processed otherwise. Therefore, it is possible to replenish the developer container with the developer of which the toner concentration is adjusted within the proper range.

If the hopper further includes second stirring member for stirring the temporarily retained developer, the arrangement is more preferable in the point that the replenishment of the developer of which the toner concentration is adjusted within the proper range becomes possible.

Moreover, as a means for solving the above problems, the invention provides an image forming apparatus including any one of the developing devices described above.

According to the invention, the toner concentration of the developer is detected at the replenishment path, and the stirring member in the developer replenishing container is controlled to be driven on the basis of the detected toner concentration. Therefore, the toner concentration of the developer to be replenished into the developer container can be adjusted within the desired range, and a satisfactory image forming process can be performed.

### BRIEF DESCRIPTION OF THE DRAWINGS

FIG. 1 is a schematic view of an image forming apparatus according to the present embodiment;

FIG. 2 is a schematic sectional view showing the developing device of FIG. 1;

FIG. 3 is a schematic sectional view showing the developer container of FIG. 2;

FIG. 4 is a schematic view showing a developer replenishment path from the developer replenishing container to the developer container of FIG. 1;

FIG. 5 is a schematic sectional view showing the developer replenishing container of FIG. 4;

FIG. 6 is a block diagram of the image forming apparatus of the present embodiment;

FIG. 7 is a flow chart showing a developer replenishing process according to the present embodiment;

FIG. 8 is a graph showing a relation between an output value of the permeability sensor shown in FIG. 4 and a toner concentration;

FIG. 9 is a table of stirring speed showing a relation to the toner concentration for use in calculating a stirring speed change rate in the developer replenishing process by the control unit shown in FIG. 6;

FIG. 10 is a schematic view showing a developer replenishment path from a developer replenishing container to a developer container according to another embodiment; and

FIG. 11 is a flow chart showing a developer replenishing process according to another embodiment.

### DETAILED DESCRIPTION OF THE INVENTION

Embodiments of the invention will be described with reference to the accompanying drawings. It is noted that, in the following description, the types, combinations, shapes, relative configurations and so on of the constituent elements are not limited only to the technical scope of the invention unless specifically described. Moreover, although the terms (e.g., “upper”, “lower”, “one end”, “the other end” etc.), which appropriately indicate specific directions and positions as occasion demands, are used, those terms are used to facilitate the understanding of the invention with reference to the drawings, and the technical scope of the invention is also not limited by the meanings of those terms.

### (Construction)

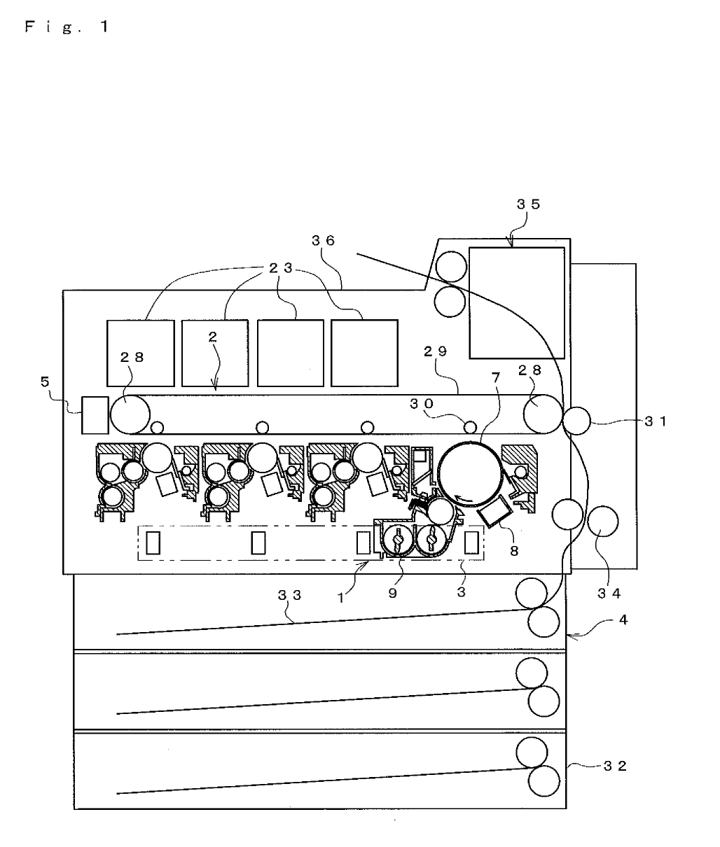

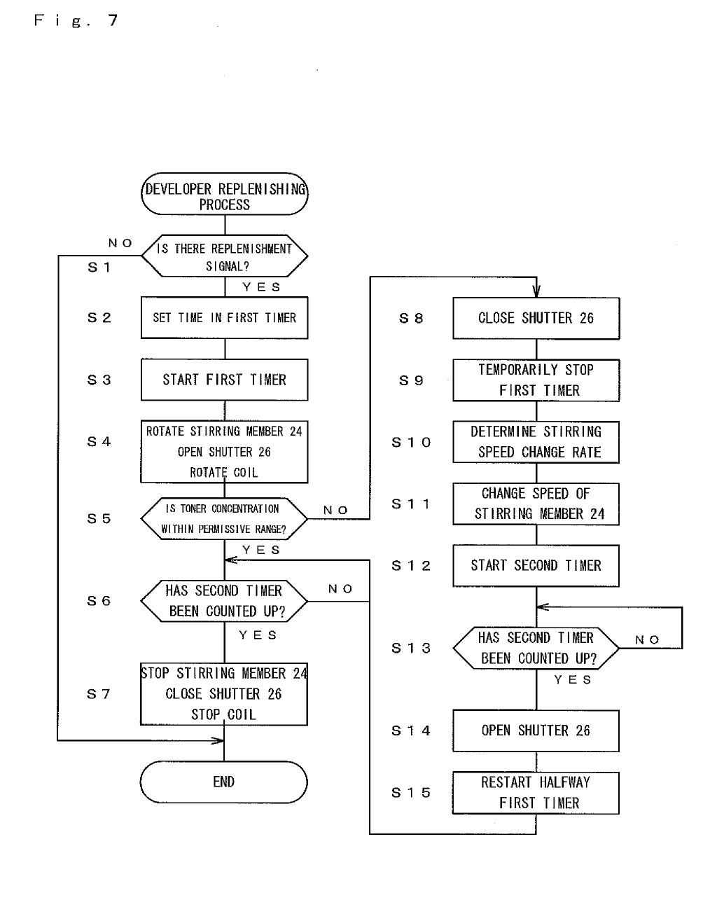

FIG. 1 shows, in particular, a so-called trickle system image forming apparatus, which is replenished with not only a toner but also a developer, among electrophotographic systems that use a two-component developer. The image forming apparatus generally includes an image forming unit 1, a transfer unit 2, an exposure unit 3, a paper feed unit 4, a cleaning unit 5, a control unit 6 (see FIG. 6) and so on.

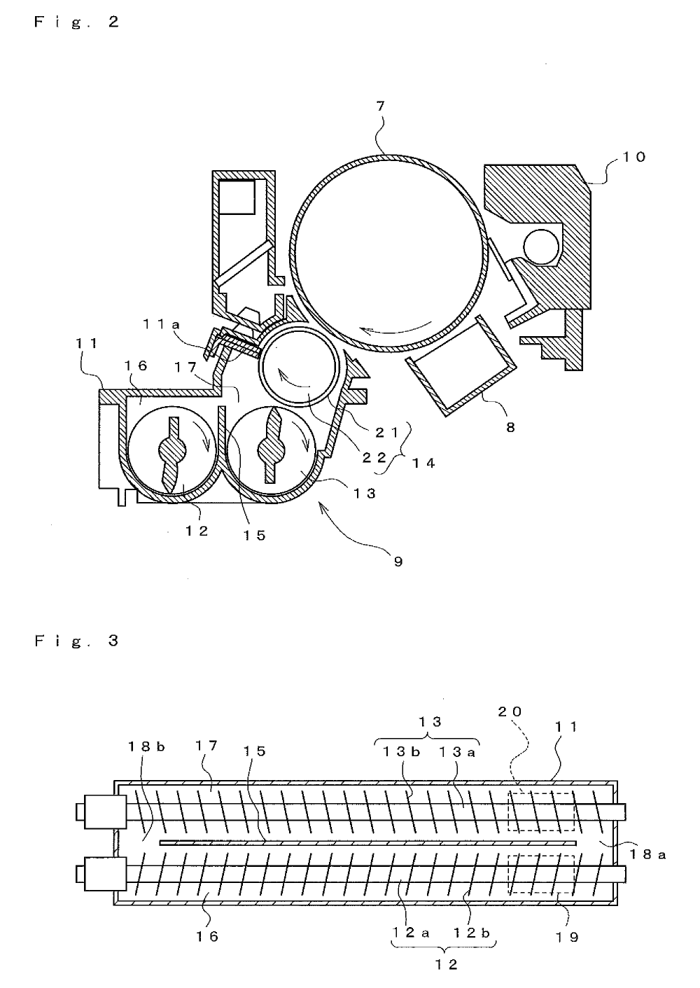

The image forming unit 1 is placed in four places along an intermediate transfer belt 29 of the transfer unit 2 and forms a color image on the surface of the intermediate transfer belt 29 by performing image formation of yellow (Y), magenta (M), cyan (C) and black (Bk) from the left-hand side. As shown in FIG. 2, each image forming unit 1 has a charger 8, a developing device 9, a cleaning device 10 and so on around a photoconductive drum 7.

The charger 8 forms a prescribed surface potential on the surface of the photoconductive drum 7. The surface potential becomes an electrostatic latent image by being exposed by the exposure unit 3.

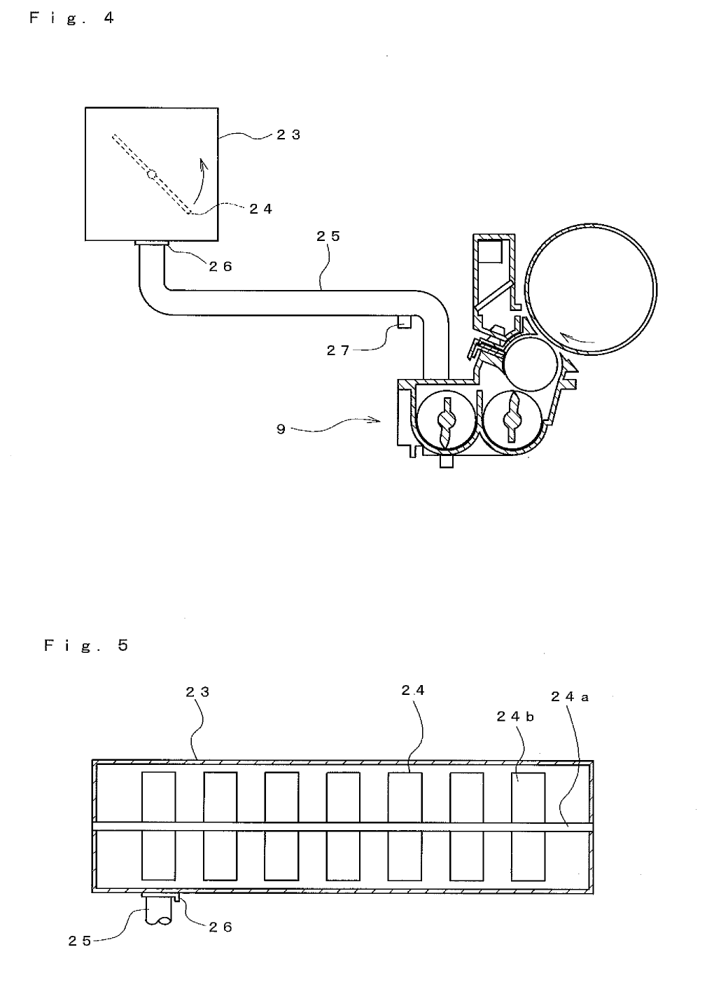

As shown in FIGS. 2 and 3, the developing device 9 receives a stirring screw 12, a feed screw 13 and a developing roller 14 in a developer container 11.

As shown in FIG. 3, the developer container 11 has a generally box-like elongate shape extended from one end side to the other end side and is internally divided into two parts of a first compartment 16 and a second compartment 17 extended along the lengthwise direction by a partition wall 15. It is noted that both ends of the first compartment 16 and the second compartment 17 communicate with each other via communicating portions 18a, 18b, so that the received developer circulatingly moves while being stirred.

A developer replenishing inlet 19 is formed on one end side of the first compartment 16, and the developer is replenished from a corresponding developer replenishing container 23 as described later. In this case, a two-component developer containing toner and carrier is used as the developer. However, the developer may further contain an external additive and the like in the developer. It is noted that the toner concentration of the developer preparatorily received in the developer container 11 is set to 7% and the toner concentration of the developer replenished from the developer replenishing container 23 is set to 80% (the carrier density is set to 20%, normally within a range of 10 to 20%).

On the other hand, a developer discharge outlet 20 is formed on one end side of the second compartment 17, so that the deteriorated developer does not remain in the developer container 11 for a long term by appropriately discharging the developer.

The stirring screw 12 has a construction in which a helical blade 12b is provided around a rotary shaft 12a and is placed in the first compartment 16. The stirring screw 12 stirs the developer while conveying the developer from one end side to the other end side by being rotationally driven.

Like the stirring screw 12 described above, the feed screw 13 has a construction in which a helical blade 13b is provided around a rotary shaft 13a and is placed in the second compartment 17. The feed screw 13 conveys the developer from the communicating portion 18b side to the communicating portion 18a side and feeds the developer to the developing roller 14 by being rotationally driven.

In the developing roller 14, as shown in FIG. 2, a plurality of permanent magnets 25 are received in a cylindrical sleeve 24 (in this case, five permanent magnets S2, N2, S1, N1, S3 are arranged in this order in the clockwise direction). The sleeve 21 is constructed so as to rotate in the arrow direction by sleeve driving member (not shown).

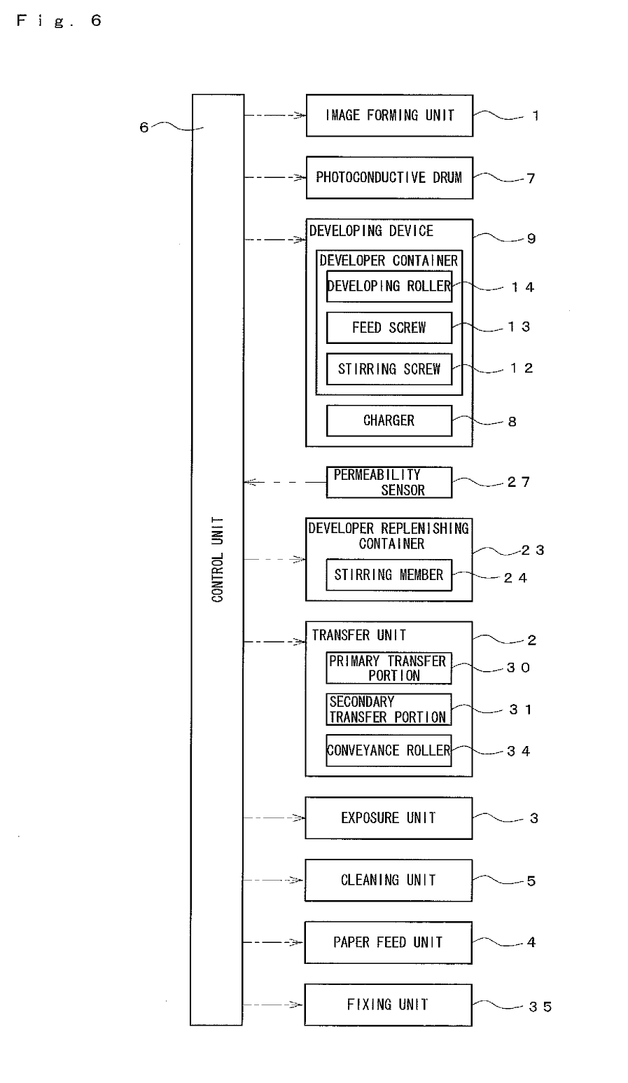

As shown in FIGS. 4 and 5, the developer replenishing container 23 that supplies a replenishment two-component developer (hereinafter simply referred to as a developer) constituted of toner and carrier is made detachable above the developing device 9. The developer received in the developer replenishing container 23 is arbitrarily stirred by the stirring member 24. The stirring member 24 is formed by integrating flat plate-shaped paddles 24b in a plurality of portions at prescribed intervals with the circumference of a rotary shaft 24a. The lower surface of the developer replenishing container 23 and the upper surface of the developer container 11 are connected with each other via a replenishment pipe 25 that constitutes a replenishment path. A replenishing port of the developer replenishing container 23 is made openable by a shutter 26. Whether or not to replenish the developer from the developer replenishing container 23 into the developer container 11, i.e., permission or refusal of the replenishment is determined depending on the opening and closing position of the shutter 26.

A permeability sensor 27 that is the developer detecting member is placed somewhere along the replenishment pipe 25. The permeability of the developer, which depends on the toner concentration, decreases as the toner concentration increases or increases as the toner concentration decreases. Accordingly, a difference in the permeability of the developer located in the detection region is outputted as a frequency by the permeability sensor 27, and the toner concentration is calculated in accordance with the graph of FIG. 8. Moreover, a rotation coil (provided by winding a wire material in a coil shape, placing the wound portion along the inner peripheral surface of the replenishment pipe 25 and making it rotationally drivable) or the like (not shown) is received in the replenishment pipe 25, and the clogging of the developer is prevented by arbitrarily rotating it.

In the developer container 11, the shutter 26 is opened and the rotation coil is rotated for a predetermined time on the basis of a replenishment signal to replenish a predetermined amount of developer from the developer replenishing container 23 into the developer container 11 as described later.

As shown in FIG. 2, after transfer onto the surface of the photoconductive drum 7, the cleaning device 10 cleans the toner remaining on its surface.

The transfer unit 2 is constructed so that the intermediate transfer belt 29 is looped around one pair of support rollers 28 and the support roller 28 is driven by driving member (not shown) to circulatingly move the intermediate transfer belt 29 in the arrow direction and includes a primary transfer portion 30 and a secondary transfer portion 31.

The exposure unit 3 applies a light of laser beam to the photoconductive drum 7 to form an electrostatic latent image corresponding to image data read by a scanner (not shown).

The paper feed unit 4 successively conveys recording media 33 received in a cassette 32 to the secondary transfer portion 31 via a conveyance roller 34. A toner image is transferred onto the recording medium 33 conveyed to the secondary transfer portion 31, and the transferred toner image is fixed by a fixing unit 35 and thereafter ejected to a copy receiving tray 36.

The cleaning unit 5 can move so as to come in contact with and apart from the intermediate transfer belt 29 and is able to collect the toner remaining on the intermediate transfer belt 29 by approaching the belt.

The control unit 6 executes a developer replenishing process on the basis of a detection voltage inputted from the permeability sensor 27 as described later.

### (Operation)

Operation of the image forming apparatus constructed as above is described next.

During image formation, color print data obtained by reading an image or image data outputted from a personal computer or the like are subjected to predetermined signal processing and thereafter transmitted to each image forming unit 1 as image signals of the colors of yellow (Y), magenta (M), cyan (C) and black (Bk).

In each image forming unit 1, the latent image is formed by applying a light of laser beam modulated by an image signal onto each photoconductive drum 7. Then, toner is supplied from the developing device 9 to the photoconductive drum 7.

In the developing device 9, the developer received in the developer container 11 is circulated while being stirred by rotationally driving the stirring screw 12 and the feed screw 13. Then, toner is supplied from the feed screw 13 to the developing roller 14, scraped off to a specified amount by a regulating member 25 and thereafter conveyed to the photoconductive drum 7.

As a result, toner images of yellow, magenta, cyan and black are formed on each photoconductive drum 7. The formed toner images of yellow, magenta, cyan and black are primarily transferred by being successively superposed on the moving intermediate transfer belt 29 in the primary transfer portion 30. The thus-formed toner images superposed on the intermediate transfer belt 29 move to the secondary transfer portion 31 in accordance with the movement of the intermediate transfer belt 29.

Moreover, a recording medium 33 is fed from the paper feed unit 4. The fed recording medium 33 is conveyed in between the secondary transfer portion 31 and the intermediate transfer belt 29 by the conveyance roller 34, and the toner images formed on the intermediate transfer belt 29 are transferred. The recording medium 33 on which the toner images have been transferred is further conveyed to the fixing unit 35, and the transferred toner images are fixed and thereafter ejected to the copy receiving tray 36.

In the developing device 9, the toner concentration of the received developer decreases as a consequence of the supply of the toner to the photoconductive drum 7, and the carrier deteriorates due to the use thereof for a long term. Therefore, the discharge and replenishment of the developer are arbitrarily performed.

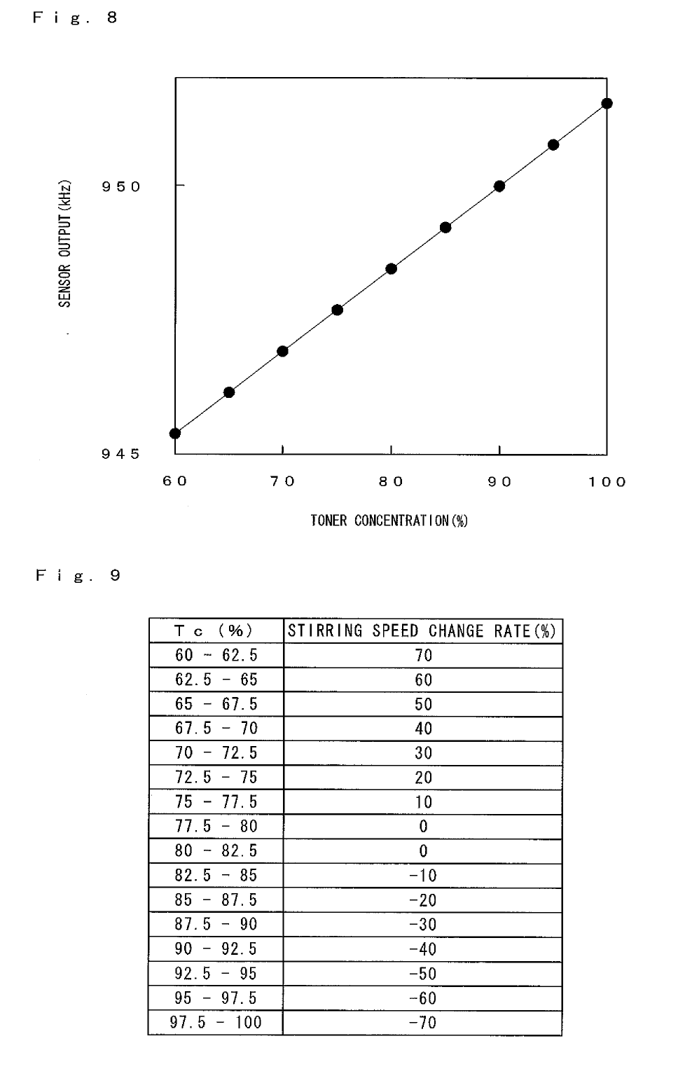

In the developer replenishing process, as shown in the flow chart of FIG. 7, it is first judged whether or not the input of the replenishment signal is present (step S1). It has been determined whether or not the replenishment signal is outputted depending on whether or not the developer container 11 needs to be replenished with the developer by a conventionally well-known method.

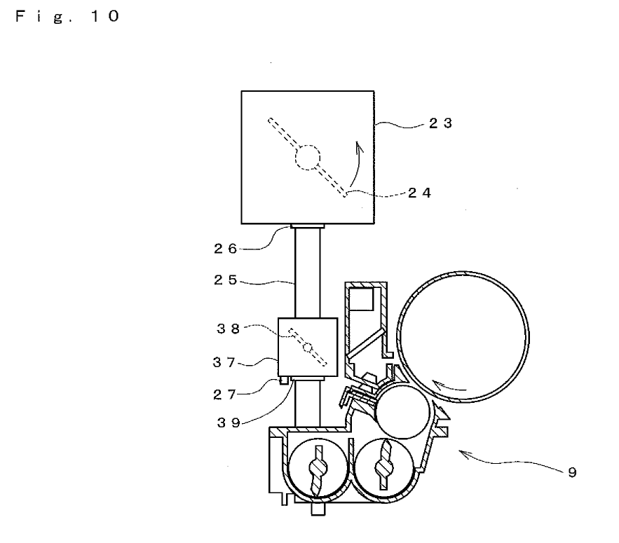

If the replenishment signal is inputted (step S1: YES), a replenishment time is set in a first timer (step S2). In this case, the replenishment time is determined in correspondence with a difference in the calculated toner concentration by a conventionally well-known method. Then, counting by the first timer starts (step S3). Moreover, the stirring member 24 starts rotating, the shutter 26 is opened, and the coil in the replenishment pipe 25 starts rotating (step S4). In this case, the stirring member 24 in the developer replenishing container 23 is rotated at a reference speed, so that the toner concentration on the replenishing port side is maintained within a permissible range (the change rate of the stirring speed becomes ±0% in the table of stirring speed of FIG. 9 as described later).

Subsequently, the toner concentration of the developer in the replenishment pipe 25 is calculated in accordance with the graph of FIG. 8 on the basis of a detection signal at the permeability sensor 27, and it is judged whether or not the calculated toner concentration is within the permissible range (step S5). In this case, the permissible range of the toner concentration is set to 77.5 to 82.5% (not lower than 77.5% and lower than 82.5%). When it is judged that the toner concentration is within the permissible range, count-up of the first timer is awaited (step S6), and this occurrence is followed by stopping the rotation of the stirring member 24, closing the shutter 26, stopping the rotation of the coil in the replenishment pipe 25 (step S7) and ending the replenishing process. As described above, the stirring member 24 and the coil are rotated only while the counting by the first timer is executed, and therefore, the deterioration of the carrier is suppressed to a necessary minimum.

On the other hand, if it is judged that the calculated toner concentration is outside the permissible range, the shutter 26 is closed (step S8), and the counting of the first timer is temporarily stopped (step S9). Then, the stirring speed change rate is determined in accordance with the stirring speed table of FIG. 9 on the basis of the calculated toner concentration (step S9). In this case, the range of 60 to 100% in which the toner concentration of the developer to be replenished is considered changeable is divided in units of 2.5%, and the change ratio of the stirring speed is set. Within the permissible range in which the toner concentration is 77.5 to 82.5%, the change rate of the stirring speed is set to ±0%, and the stirring member 24 is rotationally driven at a preset reference speed. The reference speed is set to a value such that the amount of the carrier gathering on the lower side by its own weight and the amount of carrier lifted up by the stirring paddles become almost equal to each other when the stirring member 24 is rotated at the reference speed. Then, the speed increases or decreases by 10% with respect to the reference speed every time it deviates by 2.5% from the permissible range. However, the table of stirring speed of FIG. 9 is one example, and the invention is not limited to this. For example, the division rate of the range of change in the toner concentration and the change ratio of the stirring speed and so on can freely be set according to various conditions of the amount of the developer received in the developer replenishing container 23 and so on.

If the stirring speed is determined, the stirring member 24 is rotationally driven at the determined stirring speed (step S11). In the case of deviation toward the lower side from the permissible range, or, for example, when the detected toner concentration is 75%, the stirring speed is made 10% faster than the reference speed. By this operation, the developer in the developer replenishing container 23 is stirred at a speed higher than the normal speed, and the carrier gathering more than necessary in the vicinity of the replenishing port on the lower side can be moved upward, so that the toner concentration is adjusted to fall within the permissible range. Moreover, when the detected toner concentration is 85%, the stirring speed is made 20% slower than the reference speed. By this operation, the carrier easily gathers rather than the upward movement of the carrier in the vicinity of the replenishing port on the lower side, and conversely adjustment is performed so that the toner concentration falls within the permissible range in an early stage.

Then, counting of a second timer is started (step S12), and if the second timer is counted up (step S13), the shutter 26 is opened (step S14). Subsequently, if the counting of the first timer is restarted from the time of temporary stop (step S15) and the program flow returns to step S6 to count up the first timer, then the program flow proceeds to step S7 as in the above case.

As described above, according to the above embodiment, the stirring member 24 in the developer replenishing container 23 is rotationally driven on the basis of the toner concentration of the developer immediately before being replenished into the developer container 11. That is, the stirring speed is further increased as the toner concentration further decreases from the lowest value of the permissible range or further decreased when the toner concentration further increases from the permissible range. With this arrangement, an appropriate toner concentration can be reliably obtained.

It is noted that the invention is not limited to the construction described in the above embodiment but allowed to be variously changed.

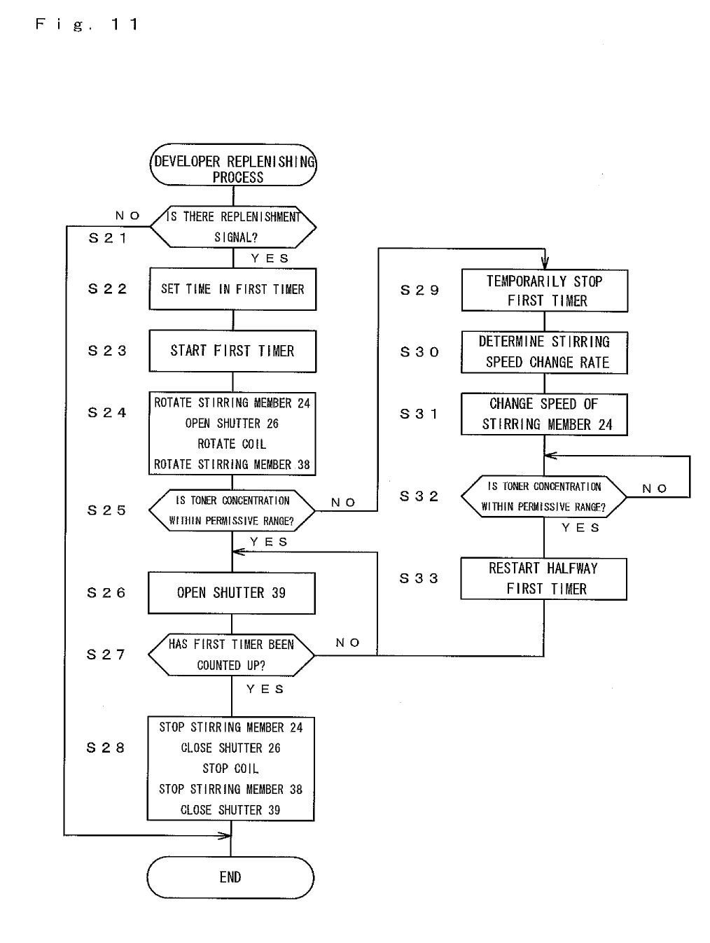

FIG. 10 shows a construction in which a hopper 37 is provided somewhere along the replenishment path, and the developer to be replenished from the developer replenishing container 23 to the developer container 11 is temporarily retained.

A stirring member 38 having a construction similar to that of the one provided in the developer replenishing container 23 is provided in a hopper 37. It is noted that the stirring member 38 stirs the developer in the hopper 37 so that the toner and the carrier are distributed at an almost uniform ratio throughout the whole. Moreover, a lower opening of the hopper 37 is opened and closed by a shutter 39. Further, the permeability sensor 27 is provided at the hopper 37, and the stirring speed of the stirring member 38 is controlled to be driven on the basis of the toner concentration of the developer stirred in the hopper 37. The other constructions are almost the same as those described in the above embodiment.

The construction shown in FIG. 10, in which the developer replenishing process is basically similar to that of the above embodiment, differs in that the opening and closing operation of the shutter 39 provided at the hopper 37 is performed.

That is, as shown in the flow chart of FIG. 11, if the replenishment signal is inputted (step S21), the time of the first timer is set (step S22) and started (step S23). Then, by rotating the stirring member 24 and opening the shutter 26, the developer is supplied into the hopper 37 while rotating the rotation coil. In the hopper 37, the stirring member 38 is rotated to stir the supplied developer in, for example, a state in which the developer for filling of about a half of the capacity is retained (step S24). Subsequently, the toner concentration in the hopper 37 is detected by the permeability sensor 27, and it is judged whether or not the detected toner concentration is within the permissible range (step S25). When the concentration is within the permissible range, the shutter 39 is opened (step S26), and the developer in the hopper 37 is replenished as it is into the developer container 11. Subsequently, if the first timer is counted up (step S27), the stirring members 24, 38 and the rotation coil are stopped, and the shutters 26, 39 are closed (step S28).

When the concentration is not within the permissible range, the first timer is temporarily stopped (step S29), and the stirring speed change rate of the stirring member 24 in the developer replenishing container 23 is determined (step S30) Then, the stirring member 24 is rotated at the determined stirring speed (step S31). It is noted that the toner concentration in the vicinity of the replenishing port of the developer replenishing container 23 is decreased when the toner concentration in the hopper 37 is higher than the permissible range or increased when the concentration is low. Then, by supplying the developer at a toner concentration that deviates from the permissible range as described above into the hopper 37, adjustment is performed so that the toner concentration in the hopper 37 falls within the permissible range. In this case, it is preferable to make the supply rate of the developer to the hopper 37 about halt the amount of the developer that has already been received (half the capacity) to allow the stirring of the stirring member 38 to be smoothly performed.

Subsequently, the toner concentration in the hopper 37 is detected again by the permeability sensor 27, and it is judged whether or not the detected toner concentration is within the permissible range (step S32). When the concentration falls within the permissible range, the first timer is restarted from the time of stop of the first timer in step S29 (step S33), and the program flow returns to the step S26 to execute similar processing.

It is proper to set the supply rate of the developer into the hopper 37 so that the total toner concentration of the developer in the hopper 37 falls within the permissible range in accordance with the volume and the toner concentration of the developer already retained in the hopper 37 and the toner concentration of the developer to be newly added. Moreover, if the toner concentration in the vicinity of the replenishing port of the developer replenishing container 23 is detected by the permeability sensor 27 provided separately, the toner concentration in the hopper 37 can be more accurately adjusted.

Moreover, although the shutter 26 of the developer container 11 remains open in steps S29 through S31 in the flow chart of FIG. 11, it is acceptable to temporarily close the shutter and to replenish the hopper 37 with the developer by opening the shutter 26 after awaiting for a lapse of time during which the toner concentration in the vicinity of the replenishing port comes to have the desired value.

As described above, the developer to be replenished into the developer container 11 is temporarily retained and stirred in the hopper 37, and therefore, the toner concentration can be put into a uniform state. Therefore, the developer adjusted to the desired toner concentration can be replenished into the developer container 11, and a satisfactory image forming process can be performed.

It is acceptable to provide magnetizing member for the developer replenishing container 23 or the stirring member 24 (both are acceptable).

As the magnetizing member, a construction such that the developer container 11 or the stirring member 24 are made to function as a magnetizable electromagnet by winding a coil (not shown) around the outer peripheral surface of the developer container 11 or the rotary shaft of the stirring member 24 and electrifying the coil can be adopted. Moreover, it is also possible to cover the permanent magnet 22 with a magnetic shielding material and to bring the material in contact with the developer container 11 or the stirring member 24 only in the case of magnetization. Moreover, the portion to be magnetized is only required to be located in the vicinity of the replenishing port and able to attract the carrier by directly or indirectly exerting a magnetic force on the carrier to restrain or prevent the carrier from being discharged from the replenishing port.

According to the above construction, the toner concentration can be adjusted by controlling the amount of the carrier to be replenished into the developer container 11. Moreover, the carrier is not stirred more than necessary as in the case where the stirring members 24, 38 are used, and therefore, the deterioration thereof can be suppressed.

When the coil is employed, it is preferable to change the electrification rate in accordance with the detected toner concentration. For example, it is proper to discharge the carrier from inside the developer replenishing container 23 by reducing the electrification rate when the toner concentration is high and to make the carrier remain in the developer replenishing container 23 by increasing the electrification rate when the toner concentration is low.

According to the arrangement, the capture rate of the carrier can be adjusted in accordance with a difference in the detected toner concentration, and therefore, the toner concentration can be finely adjusted.

Moreover, although it is preferable to provide the stirring member 24 in the developer replenishing container 23 even in the construction that has the magnetizing member, its effect can be sufficiently produced even when the member is not provided in the case where the coil is wound around the developer replenishing container 23. That is, the toner concentration of the developer to be replenished into the developer container 11 can be appropriately adjusted.

Moreover, it is preferable to provide the hopper 37 somewhere along the replenishment pipe 25 even in the construction that has the magnetizing member, the hopper 37 is not always necessary.

1. A developing device comprising:
a developer container in which a developer containing toner and carrier is received;
a developer replenishing container in which a developer containing toner and carrier is received and which replenishes the developer container with the developer;
a replenishment path which connects a upper portion of the developer container with an lower portion of the developer replenishing container;
stirring member for stirring the developer in the developer replenishing container;
toner concentration detecting member for detecting a toner concentration of the developer in the replenishment path; and
control unit for stirring the developer in the developer replenishing container by controlling driving of the stirring member on the basis of the toner concentration detected by the toner concentration detecting member.

2. The developing device as claimed in claim 1, wherein
the control unit controls, when the toner concentration detected by the toner concentration detecting member is higher than a preset reference concentration, driving of the stirring member at a stirring speed smaller than the reference speed.

3. The developing device as claimed in claim 1, wherein
the control unit controls, when the toner concentration detected by the toner concentration detecting member is lower than a preset reference concentration, driving of the stirring member at a stirring speed greater than the reference speed.

4. The developing device as claimed in claim 1, wherein
the control unit increases or decreases a stirring speed by controlling driving of the stirring member in accordance with a level of the toner concentration detected by the toner concentration detecting member.

5. The developing device as claimed in claims 1, wherein
the device comprises magnetizing member capable of temporarily magnetizing the stirring member, and
the control unit captures the carrier in the developer replenishing container by temporarily magnetizing the stirring member by the magnetizing member when the toner concentration detected by the toner concentration detecting member is lower than the preset reference concentration.

6. The developing device as claimed in claims 1, wherein
the device comprises magnetizing member capable of temporarily magnetizing the developer replenishing container, and
the control unit captures the carrier in the developer replenishing container by temporarily magnetizing the developer replenishing container by the magnetizing member when the toner concentration detected by the toner concentration detecting member is lower than a preset reference concentration.

7. A developing device comprising:
a developer container in which a developer containing toner and carrier is received;
a developer replenishing container in which a developer containing toner and carrier is received and which replenishes the developer container with the developer;
a replenishment path which connects a upper portion of the developer container with an lower portion of the developer replenishing container;
stirring member for stirring the developer in the developer replenishing container;
toner concentration detecting member for detecting a toner concentration of the developer in the replenishment path;
magnetizing member for temporarily magnetizing the developer replenishing container or the stirring member; and
control unit for capturing the carrier in the developer replenishing container by temporarily magnetizing at least either one of the developer replenishing container and the stirring member by the magnetizing member when the toner concentration detected by the toner concentration detecting member is lower than a preset reference concentration.

8. A developing device comprising:
a developer container in which a developer containing toner and carrier is received;
a developer replenishing container in which a developer containing toner and carrier is received;
stirring member for stirring the developer in the developer replenishing container;
a replenishment path which connects the developer container with the developer replenishing container and replenishes the developer container with the developer;
a hopper which is connected somewhere along the replenishment path and temporarily retains the developer directed from the developer replenishing container toward the developer container;
toner concentration detecting member for detecting a toner concentration of the developer in the hopper; and
control unit for permitting replenishment of the developer from the hopper to the developer container when the toner concentration detected by the toner concentration detecting member is within a preset reference range, refusing the replenishment when the concentration is outside the reference range, adjusting the toner concentration by controlling driving of the stirring member, and thereafter making the hopper supply the developer.

9. The developing device as claimed in claim 8, wherein
the hopper further comprises second stirring member for stirring the developer retained temporarily.

10. An image forming apparatus comprising the developing device claimed in claims 1.
